(19) United States
(12) Patent Application Publication
(10) Pub. No.: US 2016/0221041 A1
(43) Pub. Date: Aug. 4, 2016

(54) AUTOMATIC POUCH SORTING APPARATUS AND AUTOMATIC POUCH SORTING METHOD

(71) Applicant: Mondi KSP CO., LTD., Anyang-si (KR)

(72) Inventor: Byoung-gu Cho, Seoul (KR)

(21) Appl. No.: 15/094,198

(22) Filed: Apr. 8, 2016

Related U.S. Application Data
(63) Continuation of application No. PCT/KR2013/008997, filed on Oct. 8, 2013.

(51) Int. Cl. B07C 5/34

(52) U.S. Cl. CPC B07C 5/3404; B07C 5/3412

(57) ABSTRACT

Disclosed are an automatic pouch sorting apparatus and an automatic pouch sorting method, which can sort out a defective pouch among a plurality of disordered pouches and automatically arranges them in position. The automatic pouch sorting apparatus includes: a pouch supplying section which has a pouch entrance through which a plurality of pouches is put and a pouch exit through which the plurality of put pouches are discharged in units of pieces; a pouch loading section where normal pouches are loadable; a pouch moving guide section which guides the pouch to move along a pouch moving path from the pouch exit to the pouch loading section; a pouch sensing section which is arranged in between the pouch supplying section and the pouch loading section and senses whether or not the pouch discharged from the pouch exit is normal; a pouch interceptor which selectively intercepts the pouch in order to prevent the pouch from being transferred and loaded to the pouch loading section; and a controller which controls the pouch interceptor in accordance with sensed results of the pouch sensing section so that normal pouches can be loaded to the pouch loading section but abnormal pouches cannot be loaded to the pouch loading section.

### REFERENCE TO RELATED APPLICATIONS

This is a continuation of pending International Patent Application PCT/KR2013/008997 filed on Oct. 8, 2013, which designates the United States, the entire contents of which are incorporated herein by reference.

### FIELD OF THE INVENTION

The present invention relates to an automatic pouch sorting apparatus and an automatic pouch sorting method, and more particularly to an automatic pouch sorting apparatus and an automatic pouch sorting method, which can sort out a defective pouch among a plurality of disordered pouches and automatically arranges them in position.

### BACKGROUND OF THE INVENTION

A pouch is made of a nonwoven film for containing a beverage, an ice cake or the like food, and has been widespread since a user can easily carry it and take in the food.

In general, the pouch is manufactured in a company of manufacturing a pouch, i.e. a pouch manufacturer and delivered to a food company. Then, the food company puts food or the like content into the pouch and provides it to a user in the form of a complete product.

By the way, when the pouches are delivered from the pouch manufacturer to the food company, they are arranged in order with their front sides facing in a certain direction.

However, if it is desired that the pouches are delivered in such an ordered state, a support structure is needed for supporting the pouches, thereby increasing volume and weight and thus raising transport costs.

Further, the support structure itself may be contaminated while carrying the pouches and the contaminated support structure may contaminate the pouches.

In addition, it is not only difficult to recover the support structure for supporting the pouches after the pouches are delivered to the food company, but also undesired in terms of recycling resources since the used support structure is discarded.

Accordingly, it would be better in terms of environments and transport costs if massive pouches are delivered in a disordered state and the plurality of delivered pouches are arranged and sorted out by a separate apparatus in the food company where the pouches are actually used.

### SUMMARY OF THE INVENTION

An aspect of the present invention is to provide an automatic pouch sorting apparatus and an automatic pouch sorting method, which can sort out a defective pouch among a plurality of disordered pouches and automatically arranges them in position.

The foregoing and/or other aspects of the present invention are achieved by providing an automatic pouch sorting apparatus including: a pouch supplying section which has a pouch entrance through which a plurality of pouches is put and a pouch exit through which the plurality of put pouches are discharged in units of pieces; a pouch loading section where normal pouches are loadable; a pouch moving guide section which guides the pouch to move along a pouch moving path from the pouch exit to the pouch loading section; a pouch sensing section which is arranged in between the pouch supplying section and the pouch loading section and senses whether or not the pouch discharged from the pouch exit is normal; a pouch interceptor which selectively intercepts the pouch in order to prevent the pouch from being transferred and loaded to the pouch loading section; and a controller which controls the pouch interceptor in accordance with sensed results of the pouch sensing section so that normal pouches can be loaded to the pouch loading section but abnormal pouches cannot be loaded to the pouch loading section.

The pouch may include a pouch body in which contents are contained, and an inlet through which the contents flow in to/out from the pouch body, and the pouch moving guide section may include a guide rail supporting the inlet and guiding the pouch discharged from the pouch exit to the pouch sensing section.

The pouch sensing section may be provided to sense presence of a mark formed on at least one of front and rear sides of the pouch or sense a position of the mark.

The pouch sensing section may include at least one of an image sensor for recognizing an image of the mark and a mark reader for reading the mark.

The automatic pouch sorting apparatus may further include a pouch position changer for reversing the pouch to be in position, and the controller may control the pouch position changer to change the position of the pouch to a normal state if the pouch sensing section senses that the position of the pouch is abnormal, and control the pouch interceptor so that the pouch changed to the normal state can be loaded to the pouch loading section.

Another aspect of the present invention is achieved by providing automatic pouch sorting method including: separating and discharging a plurality of pouches from a pouch supplying section in units of pieces; sensing whether the pouches discharged in units of pieces are normal or abnormal; transferring the pouch to a pouch loading section if the pouch is normal; and intercepting the pouch from being transferred to the pouch loading section if the pouch is abnormal.

The intercepting the pouch from being transferred to the pouch loading section may include: changing the position of the pouch to a normal state if the position of the pouch is abnormal; and transferring the pouch changed to the normal state to the pouch loading section.

Thus, the automatic pouch sorting apparatus and the automatic pouch sorting method according to the present invention have the following effects.

First, it is possible to reduce transport costs since massive pouches are delivered being put in a box in a disordered state.

Second, it is possible to reduce volume and weight for transport since there is no need of a support structure that has been used for aligning and delivering the pouches. Further, it is preferable in terms of recycling resources since the support structure is not wasted.

Third, it is possible to raise productivity since a defective pouch is automatically determined and sorted out from a plurality of disorderedly arranged pouches and the plurality of pouches are arranged in position.

Fourth, pouches are free from contamination caused by the contaminated support structure for aligning the pouches since there is no need of the support structure.

### BRIEF DESCRIPTION OF THE DRAWINGS

FIG. 1 is a plan view of an automatic pouch sorting apparatus according to a first embodiment of the present invention,

FIG. 2 is a partial enlarged lateral view taken along line II-II of FIG. 1,

FIG. 3 is a schematic perspective view of a pouch to be sorted out by the automatic pouch sorting apparatus of FIG. 1,

FIG. 4 is a partial schematic plan view for explaining a sorting process in the automatic pouch sorting apparatus of FIG. 1,

FIG. 5 is a plan view of an automatic pouch sorting apparatus according to a second embodiment of the present invention,

FIG. 6 is a flowchart of an automatic pouch sorting method according to the present invention, and

FIG. 7 is a flowchart of another automatic pouch sorting method according to the present invention.

### DETAILED DESCRIPTION OF THE INVENTION

Below, an automatic pouch sorting apparatus and a automatic pouch sorting method according to embodiments of the present invention will be described in detail with reference to accompanying drawings.

In the following embodiments, like numerals refer to like elements, and repetitive descriptions will be avoided as necessary.

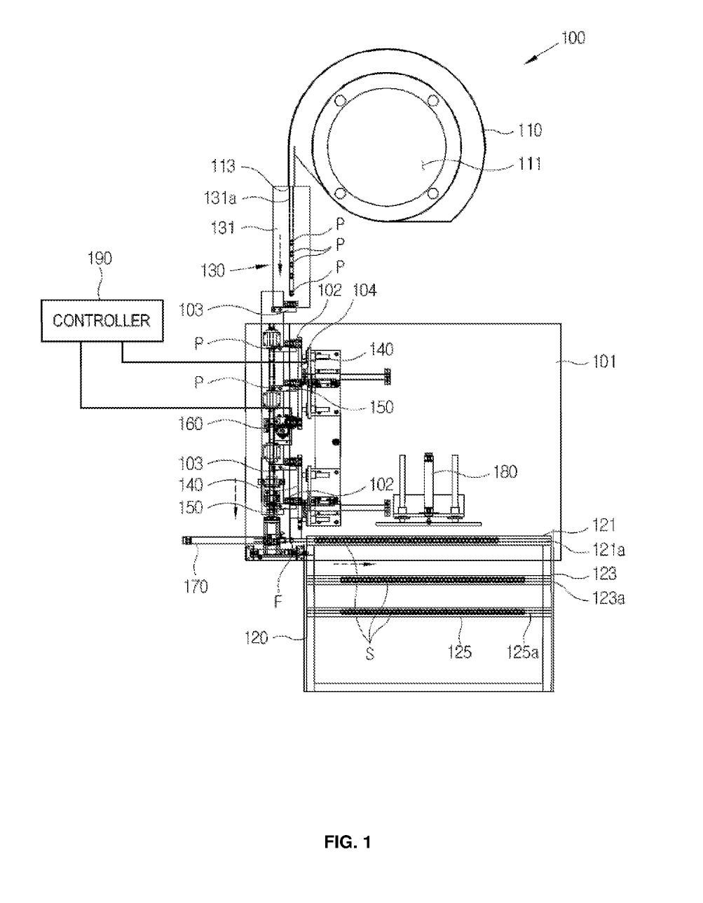

As shown in FIG. 1 to FIG. 3, an automatic pouch sorting apparatus 100 according to a first embodiment of the present invention includes a pouch supplying section 110 which has a pouch entrance 111 through which a plurality of pouches is entered and a pouch exit 113 through which the plurality of put pouches are discharged in units of pieces; a pouch loading section 120 where normal pouches S are loadable; a pouch moving guide section 130 which guides the pouch P to move along a pouch moving path from the pouch exit 113 to the pouch loading section 120; a pouch sensing section 140 which is arranged in between the pouch supplying section 110 and the pouch loading section 120 and senses whether or not the pouch discharged from the pouch exit 113 is normal; a pouch interceptor 150 which selectively intercepts the pouch in order to prevent the pouch from being transferred and loaded to the pouch loading section 120; and a controller 190 which controls the pouch interceptor 150 in accordance with sensed results of the pouch sensing section 140.

The pouch supplying section 110 includes the pouch entrance 111 opened upward. The plurality of pouches is entered through the pouch entrance 111.

The pouch supplying section 110 may vibrate the plurality of pouches so as to be transferred toward the pouch exit 113 in units of pieces. That is, the pouch supplying section 110 may be achieved by a vibration feeder.

As necessary, the pouch supplying section 110 may further include a hopper (not shown) for mixing the plurality of pouches.

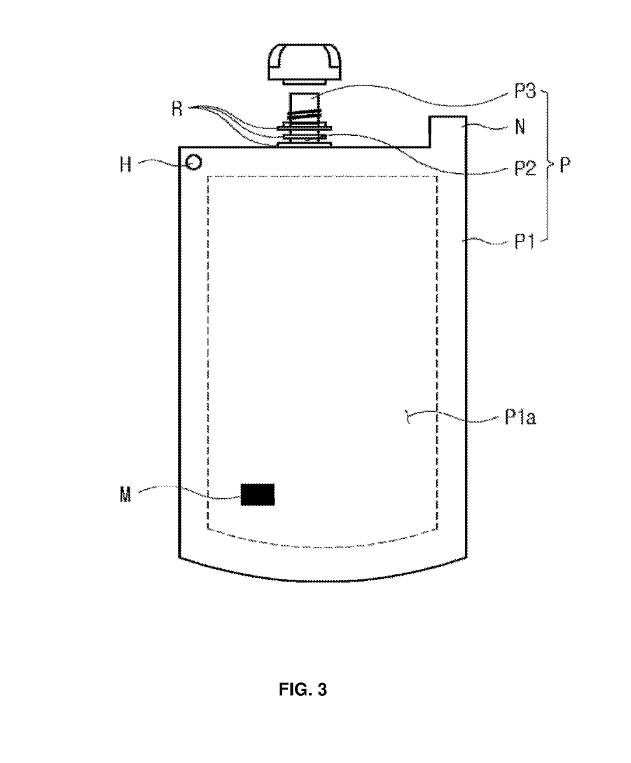

The pouch P put in the pouch supplying section 110 may include a pouch body P1 in which contents are contained, and an inlet P3 through which the contents flow in to/out from the pouch body P1 as shown in FIG. 3. The inlet P3 may further include a neck P2 protruding from the pouch body P1. The neck P2 may further include three ribs R surrounding the neck P2. These three ribs R are used in transferring the pouches in a process of sorting out the pouch or in a process of putting contents in the pouch. That is, the pouch may be transferred being guided by the moving guide section 130 supported in a space around the neck P2 formed by three ribs R. FIG. 3 shows three ribs, but not limited thereto. Alternatively, two or more than four ribs may be provided, or a shape analogous to this may be given.

Further, a predetermined mark M may be given on a front side P1a of the pouch body P1.

Alternatively, the mark M may be given on a rear side opposite to the front side P1a. The mark M may include a barcode, a quick response (QR) code or the like well-known recognition code. As necessary, the mark M may be a manufacturer's own identification character, image, color, pattern or the like visually recognizable mark. Further, the mark M may be a radio frequency identification (RFID) tag. In this case, the kind of pouch sensing section 140 (to be described later) may vary depending on the kind of mark M. If the mark M is the visual mark, the pouch sensing section 140 may include an image sensor. If the mark M is the RFID tag, the pouch sensing section 140 may include an RFID reader. Further, if the mark M is the barcode, the pouch sensing section 140 may include a corresponding barcode reader.

As necessary, an embossed mark N embossed on an external outline of the pouch body P1 or a hole mark H may be used instead of the foregoing mark M printed on the pouch body P1. If the embossed mark N or the hole mark H is employed, the pouch sensing section 140 may be achieved by a pair of photo-sensors that have a light emitter (not shown) and a light receiver (not shown). In this case, the embossed mark N or the hole mark H is arranged on a path where light emitted from the light emitter (not shown) travels to the light receiver (not shown), and it is thus possible to determine the presence of the embossed mark N or the hole mark H in accordance with whether the light receiver (not shown) senses the light emitted from the light emitter (not shown).

The pouch moving guide section 130 may include a guide rail 131 supported in between the ribs R of the neck P2 and guiding the pouch P to move.

The guide rail 131 may guide the pouch P to move from the pouch exit 113 of the pouch supplying section 110 to the pouch sensing section 140.

On the guide rail 131, the pouches P may be arranged to make the front side P1a or rear side P1b thereof face not in a certain direction but in random directions. Occasionally, there may be a defective pouch, which is not normally manufactured, among the pouches P supported on the guide rail 131.

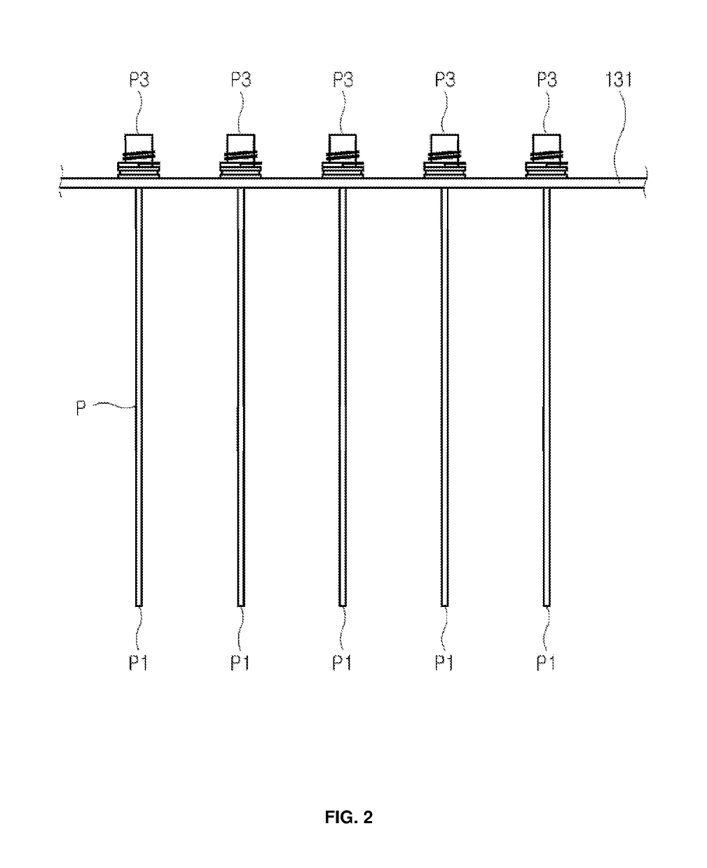

As shown in FIG. 1 and FIG. 2, the guide rail 131 includes a guide groove 131a through which the neck P2 of the pouch P can pass. The guide groove 131a is extended along the moving direction of the pouch P.

The guide groove 131a does not allow the rib R of the neck P2 to pass therethrough so that the guide rail 131 can support a lower side of the inlet P3.

The pouch exit 113 may be higher than the pouch sensing section 140 so that the guide rail 131 can be inclined. Thus, the pouch P moving along the guide groove 131a may move down from the pouch exit 113 toward the pouch sensing section 140 by its own weight. Here, force for urging the pouch P to move from the pouch exit 113 toward the pouch sensing section 140 may be given by not only the weight of the pouch P but also vibration, rotatory power, etc. of the pouch supplying section 110, which is a discharging pressure for discharging the pouch P from the pouch supplying section 110.

On the other hand, the pouch exit 113 is approximately level with the pouch sensing section 140 so that the guide rail 131 can be arranged horizontally. In this case, the pouch P may be transferred to the pouch sensing section 140 along the pouch moving direction by a pneumatic or hydraulic pusher (not shown).

For convenience, the pouch moving guide section 130 is illustrated from the pouch supplying section 110 to a stopper 103 in front of the pouch sensing section 140, and the other portion will be omitted in the drawings. Although it is not illustrated, the foregoing guide groove 131a may be extended to guide the pouch P to the pouch loading section 120 via the pouch sensing section 140 and the pouch interceptor 150.

The automatic pouch sorting apparatus 100 may further include the stopper 103 for controlling the movement of the pouch P so that the pouches P on the guide rail 131 can be sequentially transferred to the pouch sensing section 140 at predetermined intervals of time.

The stopper 103 is controlled its drive by the controller 190 at predetermined intervals of time in consideration of time taken in sensing whether or not the pouch P is normal by the pouch sensing section 140.

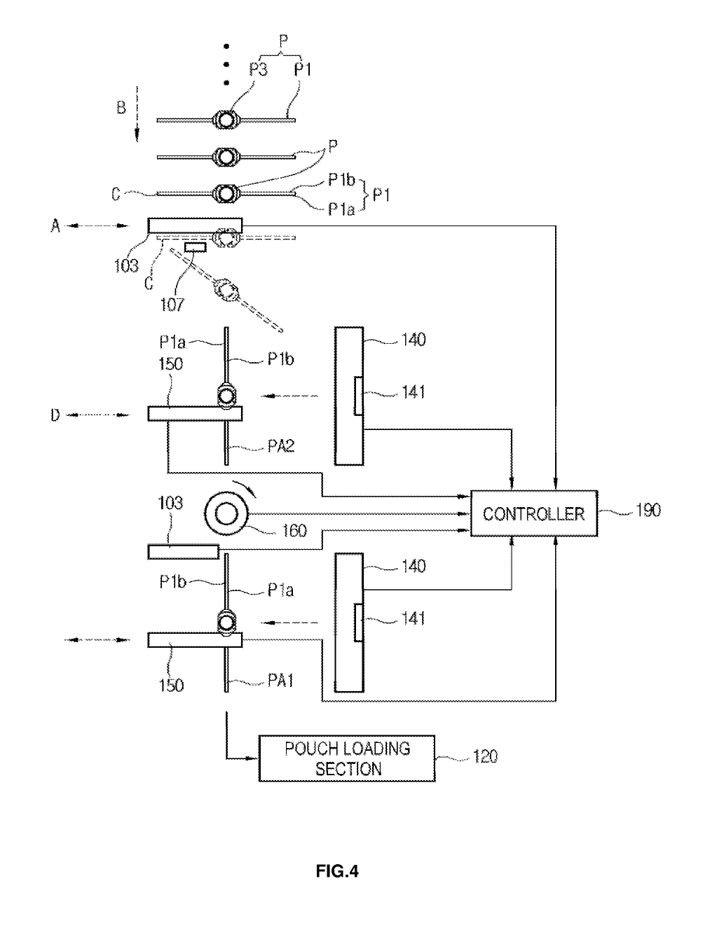

As shown in FIG. 4, the stopper 103 may be provided to reciprocate in left and right directions A between a blocking position for blocking the movement of the pouch P and a withdrawal position to be withdrawn from the blocking position and allowing the pouch P to move. In FIG. 4, the stopper 103 is in the withdrawal position. That is, the stopper 103 moves to the withdrawal position when it is completely sensed whether a proceeding pouch is normal or not under control of the controller 190. Thus, the following pouch is fed to the pouch sensing section 140.

Here, the stopper 103 may be installed to reciprocate in a main frame 101 of the automatic pouch sorting apparatus 100.

The pouch P may be arranged on the guide rail 131 so that the front side P1a and rear side P1b of the pouch body P1 can be arranged transversely to the moving direction B of the pouch P. This is to arrange the plurality of pouches P on the guide rail 131.

The pouch sensing section 140 may be provided to sense the presence of the mark H, N or M formed on the pouch P, specifically, on at least one of the front side P1a and rear side P1b of the pouch body p1, or sense the position of the mark H, N or M.

As described above, the pouch sensing section 140 may be provided to recognize the mark H, N or M in accordance with the kinds of mark H, N and M.

The pouch sensing section 140 may include the image sensor 141 to recognize the mark M if the mark M is a predetermined visual mark. Further, the pouch sensing section 140 may further include a light source (not shown), and an optical system (not shown) having a lens and/or a mirror so that the light emitted from the light source (not shown) can be focused on the mark M.

As shown in FIG. 4, the pouch P stopped by the stopper 103 is changed is position while moving toward the pouch sensing section 140. In more detail, the front side P1a or the rear side P1b of the pouch P are perpendicular to the pouch moving direction B in the previous stage before the stopper 103, but the front side P1a or the rear side P1b of the pouch P have to be turned at a predetermined angle to face the pouch sensing section 140 so that the pouch sensing section 140 can scan the mark H, N or M formed on the front side P1a or the rear side P1b. If the pouch sensing section 140 is provided to take an image at the right angle to the pouch moving direction B, the pouch P has to be rotated at the corresponding right angle.

To this end, the automatic pouch sorting apparatus 100 may further include a pouch contactor 107 that contacts one side of the pouch body P1 and rotates the pouch P with respect to the inlet P3.

As shown in a dotted line of FIG. 4, one side of the pouch body contacts the pouch contactor 107 and thus the pouch rotates at the right angle. Thus, the front side P1a or rear side P1b of the pouch P are changed to face toward the pouch sensing section 14, and the pouch sensing section 140 can sense the presence of the mark formed on the pouch body P1.

The pouch interceptor 150 is provided to selectively prevent the pouch P from moving along the pouch moving path. The pouch interceptor 150 may be similar to the foregoing stopper 103. In more detail, the pouch interceptor 150 may be provided to reciprocate in left and right directions D between a blocking position for blocking the movement of the pouch P and a withdrawal position to be withdrawn from the blocking position and allowing the pouch P to move.

The pouch interceptor 150 may contact the inlet P3 of the pouch P and prevent the pouch P from moving.

The controller 190 controls the pouch interceptor 150 so that the pouch can be loaded to the pouch loading section 120, if the pouch sensing section 140 senses that the pouch is normal. That is, if it is determined that the pouch is normal, the pouch interceptor 150 is moved to the withdrawal position so that the pouch can be transferred to the pouch loading section 120. Thus, the pouches can be loaded to the pouch loading section 120.

On the other hand, if it is determined that the pouch is abnormal, the controller 190 controls the pouch interceptor 150 so that the abnormal pouch cannot be loaded to the pouch loading section.

Suppose that the normal pouch P has the mark M formed on the front side P1a of the pouch body P1 as shown in FIG. 3. In the case of a pouch PA2 positioned in front of the pouch sensing section 140 as shown in FIG. 4, its rear side P1b is photographed by the pouch sensing section 140. Thus, the controller 190 recognizes the absence of the mark M based on an image photographed by the pouch sensing section 140, and determines that the pouch PA2 is abnormal.

Here, the abnormal state may refer to that the front side P1a and rear side P1b of the pouch PA2 are reversed or that the pouch PA2 is not exactly processed, i.e. is defective.

In the foregoing examples, the controller 190 controls the pouch interceptor 150 to move the blocking position if it is determined that the pouch PA2 is abnormal. Then, the pouch PA2 may be transferred to a defective pouch loading section (not shown) along a pouch recovery path (not shown). As necessary, the pouch PA2 may be adsorbed and intercepted from the pouch moving path so as to be transferred to the defective pouch loading section. In the case where it is determined that the front and rear sides of the pouch PA2 are reversed, the pouch PA2 may be returned to the pouch supplying section 110.

In addition, the automatic pouch sorting apparatus 100 may include another pouch sensing section 140 added at a downstream side along the pouch moving direction B, another stopper 103 for controlling the movement of the pouch in consideration of time taken in sensing of the downstream pouch sensing section 140, a position changer 160 interposed in between an upstream pouch sensing section 140 and a downstream pouch sensing section 140 and changing the position of the pouch to a normal state, and another pouch interceptor 150 added at a downstream side. Of course, the downstream pouch sensing section 140 and the position changer 160 may be excluded as necessary.

Alternatively, the automatic pouch sorting apparatus 100 may have a pair of pouch sensing sections 140 respectively arranged not in the upstream and downstream sides along the pouch moving direction B as shown in FIG. 1 and FIG. 4 but to face each other at opposite sides with respect to the pouch PA2 so that both the front side P1a and the rear side P1b of the pouch PA2 can be simultaneously photographed. In this case, the position changer 160 may be excluded.

In the case where it is determined that the pouch PA2 is abnormal, the controller 190 controls the position changer 160 to change the position of the pouch PA2. In more detail, the position changer 160 may be controlled to hold the inlet p3 of the pouch PA2 and turn it through 180 degrees. Thus, the opposite side P1a, not photographed by the upstream pouch sensing section 140, is exposed to the downstream pouch sensing section 140. Here, the pouch PA1 placed in front of the downstream pouch sensing section 140 refers to that the pouch PA2 sensed by the upstream pouch sensing section 140 is changed in position by the position changer 160.

The downstream pouch sensing section 140 takes an image of the front side P1a of the pouch PA1 changed in position. The controller 190 determines whether the mark M is present in the front side of the pouch PA1 based on the sensed results of the downstream pouch sensing section 140, i.e., based on the taken image. If there is the mark M, the controller 190 determines that the pouch PA1 is normal, and controls the pouch interceptor 150 arranged at the downstream side to be in the withdrawal position. Thus, the pouch PA1 can be transferred to the pouch loading section 120.

On the other hand, if it is determined that even the front side of the pouch PA1 changed in position has no mark M, the controller 19 determines that the pouch PA1 is defective among the foregoing abnormal states. Thus, the controller 190 controls the pouch interceptor 150 to be in the blocking position and intercept the defective pouch PA1 from being transferred to the pouch loading section 120. Here, the defective pouch PA1 may be transferred to the defective pouch loading section (not shown) along the recovery path (not shown).

The pouch loading section 120 may further include normal pouch loading rails 121, 123 and 125 formed with guide grooves 121a, 123a and 125a corresponding to the guide groove 131a of the guide rail 131.

Here, the pouch loading section 120 is a place where sorted normal pouches are temporarily stored. If the automatic pouch sorting apparatus 100 is directly connected to an apparatus for filling the normal pouches with contents, the pouch loading section 120 may correspond to the guide rails for transferring the normal pouches to the content filling apparatus.

If the normal pouch passed through the pouch interceptor 150 reaches an entrance position F of the pouch loading section 120, a pusher 170 may be driven to transfer the pouch from the entrance position to the normal pouch loading rails 121, 123 and 125.

Here, the pusher 170 may include a pneumatic or hydraulic cylinder.

Further, the automatic pouch sorting apparatus 100 may additionally include a cassette replacer 180 that moves the normal pouch loading rails 121, 123 and 125 to another position and brings new empty loading rails to the entrance position F if all the normal pouch loading rails 121, 123 and 125 are occupied with the pouches.

Here, if the automatic pouch sorting apparatus 100 is directly connected to the apparatus for filling the pouch body of the normal pouch with contents, the cassette replacer 180 may be excluded.

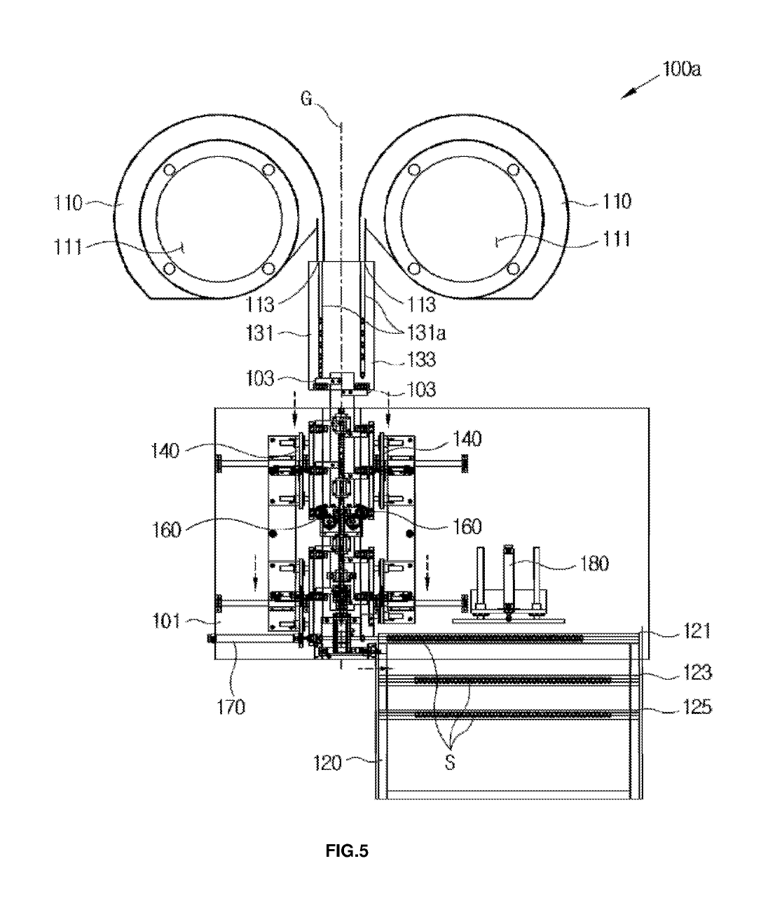

According to a second embodiment of the present invention, the automatic pouch sorting apparatus 100a may be provided in such a manner that the automatic pouch sorting apparatuses 100 according to the first embodiment are symmetrically arranged with respect to a center line G except the pouch loading section 120 as shown in FIG. 5.

That is, pouches are supplied and sorted out by a plurality of pouch supplying sections 110, a plurality of pouch moving guide sections 131, a plurality of pouch sensing sections 140 symmetrically arranged with respect to the center line G, a plurality of pouch interceptor 150 and a plurality of position changers 160, and therefore processing speed is doubled.

Here, the pouch loading section 120 may be loaded with the normal pouches simultaneously sorted out by the automatic pouch sorting apparatuses 100 symmetrically arranged with respect to the center line G. Since the automatic pouch sorting apparatus 100a according to the second embodiment includes the automatic pouch sorting apparatuses 100 according to the first embodiment symmetrically provided with respect to the center line G, the repetitive descriptions thereof will be avoided.

FIG. 5 illustrates that the pair of pouch supplying sections 110 are used to sort out the pouches, but not limited thereto. Alternatively, three or more than four pouch supplying sections 110 may be arranged to thereby speed up the process of sorting out the pouches.

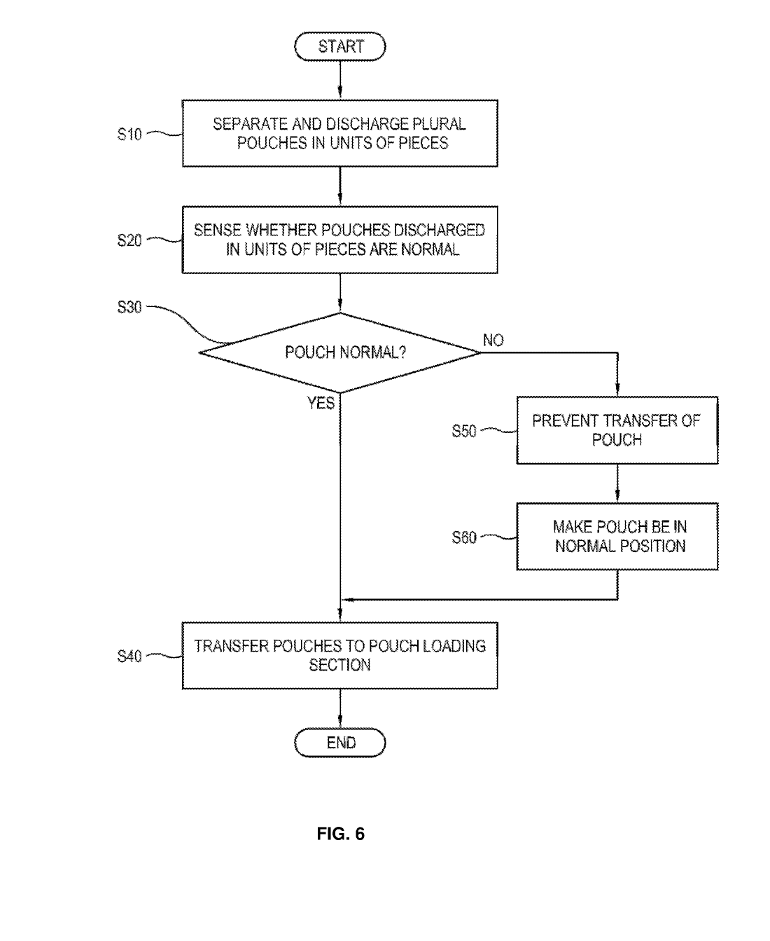

Below, an automatic pouch sorting method according to the present invention will be described with reference to FIG. 6.

First, a plurality of pouches are separated and discharged in units of pieces (S10).

Next, it is sensed whether the pouches discharged in units of pieces are normal or abnormal (S20).

An operation of putting contents into the respective pouches separated in units of pieces may be added in between the operations S10 and S20. Here, the contents may be a foodstuff such as porridge, soup, etc. or cosmetics, a beauty mask pack or the like other than the foodstuff. Likewise, there may be various kinds of contents.

If it is sensed that the pouch is normal (Yes at S30), the pouch is transferred to the pouch loading section (S40).

On the other hand, if it is determined that the pouch is abnormal (No at S30), the pouch is prevented from being transferred to the pouch loading section (S50).

If the position of the pouch is abnormal in the operation of intercepting the pouch from being transferred to the pouch loading section, the pouch is changed in position and then transferred to the pouch loading section (S60).

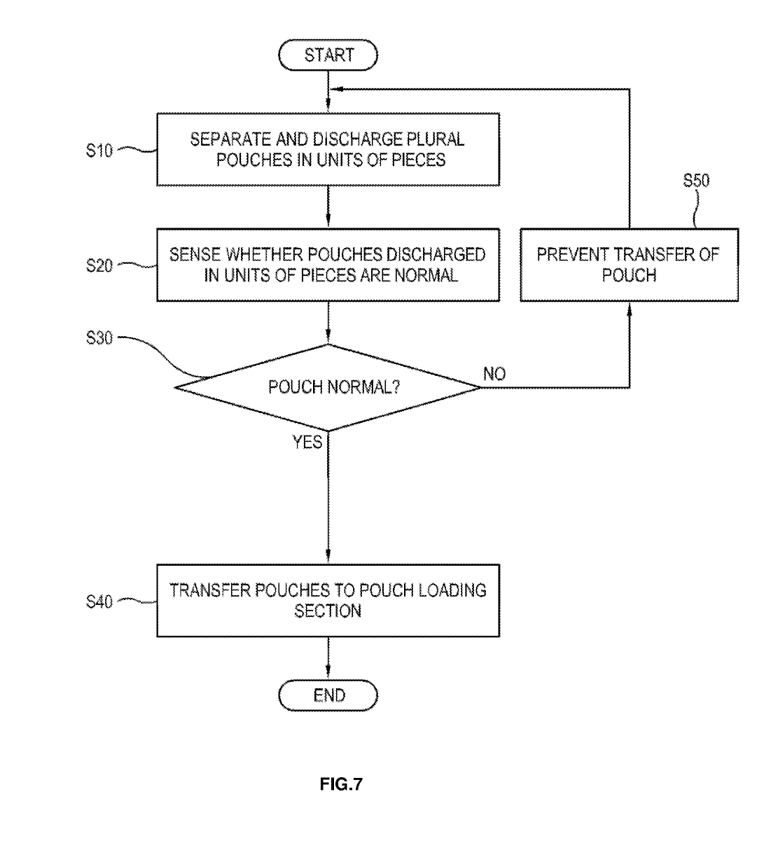

Instead of the operation S60, if the position of the pouch is abnormal in the operation of intercepting the pouch from being transferred to the pouch loading section, the abnormally positioned pouch may be returned to the pouch supplying section 110 and sorted out again as shown in FIG. 7.

The operation S40 of transferring the pouch to the pouch loading section may further include an operation of putting contents into the respective pouches. That is, the operation of filling the pouch with the content may be added not between the foregoing operations S10 and S20 but in the operation S40. Here, the contents may include foodstuffs, cosmetics other than the foodstuffs, and so on.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

The present invention is applicable to an industry of manufacturing a beverage container and putting contents into the manufactured beverage container.

What is claimed is:

1. An automatic pouch sorting apparatus comprising:
a pouch supplying section which has a pouch entrance through which a plurality of pouches is put and a pouch exit through which the plurality of put pouches are discharged in units of pieces;
a pouch loading section where normal pouches are loadable.
a pouch moving guide section which guides the pouch to move along a pouch moving path from the pouch exit to the pouch loading section.
a pouch sensing section which is arranged in between the pouch supplying section and the pouch loading section and senses whether or not the pouch discharged from the pouch exit is normal;
a pouch interceptor which selectively intercepts the pouch in order to prevent the pouch from being transferred and loaded to the pouch loading section; and
a controller which controls the pouch interceptor in accordance with sensed results of the pouch sensing section so that normal pouches can be loaded to the pouch loading section but abnormal pouches cannot be loaded to the pouch loading section.

2. The automatic pouch sorting apparatus according to claim 1, wherein the pouch comprises a pouch body in which contents are contained, and an inlet through which the contents flow in to/out from the pouch body, and
the pouch moving guide section comprises a guide rail supporting the inlet and guiding the pouch discharged from the pouch exit to the pouch sensing section.

3. The automatic pouch sorting apparatus according to claim 1, wherein the pouch sensing section is provided to sense presence of a mark formed on at least one of front and rear sides of the pouch or sense a position of the mark.

4. The automatic pouch sorting apparatus according to claim 3, wherein the pouch sensing section comprises at least one of an image sensor for recognizing an image of the mark and a mark reader for reading the mark.

5. The automatic pouch sorting apparatus according to claim 3, further comprising a pouch position changer for reversing the pouch to be in position, and
the controller controls the pouch position changer to change the position of the pouch to a normal state if the pouch sensing section senses that the position of the pouch is abnormal, and controls the pouch interceptor so that the pouch changed to the normal state can be loaded to the pouch loading section.

6. A automatic pouch sorting method comprising:
separating and discharging a plurality of pouches from a pouch supplying section in units of pieces;
sensing whether the pouches discharged in units of pieces are normal or abnormal transferring the pouch to a pouch loading section if the pouch is normal; and
intercepting the pouch from being transferred to the pouch loading section if the pouch is abnormal.

7. The automatic pouch sorting method according to claim 6, wherein the intercepting the pouch from being transferred to the pouch loading section comprises:
changing the position of the pouch to a normal state if the position of the pouch is abnormal; and
transferring the pouch changed to the normal state to the pouch loading section.

8. The automatic pouch sorting method according to claim 6, further comprising returning the pouch to the pouch supplying section if the pouch is abnormal.
